(19) United States
(12) Patent Application Publication
(10) Pub. No.: US 2021/0226999 A1
(43) Pub. Date: Jul. 22, 2021

(54) MODELING ANOMALOUSNESS OF NEW SUBGRAPHS OBSERVED LOCALLY IN A DYNAMIC GRAPH BASED ON SUBGRAPH ATTRIBUTES AND A COMMUNITY MODEL

(71) Applicant: Triad National Security, LLC, Los Alamos, MN (US)

(72) Inventors: Michael Edward Fisk, Los Alamos, NM (US); Joshua Charles Neil, Los Alamos, NM (US)

(73) Assignee: Triad National Security, LLC, Los Alamos, NM (US)

(21) Appl. No.: 17/266,916

(22) PCT Filed: Aug. 6, 2019
(86) PCT No.: PCT/US2019/045303

§ 371 Date: Feb. 8, 2021

Related U.S. Application Data
(60) Provisional application No. 62/715,686, filed on Aug. 7, 2018.

(51) Int. Cl. H04L 29/06; G06N 7/00

(52) U.S. Cl. CPC H04L 63/205; G06N 7/005

(57) ABSTRACT

Processes for determining whether new subgraphs that are observed locally in dynamic graphs are indicative of anomalous behavior are disclosed. Community models including certain factors, such as the rate of creation of new subgraphs of given structures and labels, may provide a basis for measuring the likelihood of newly observed subgraphs. For instance, edge labels including attributes for these specific shapes, such as port numbers and/or other categories, may differentiate legitimate new local occurrences thereof from those that are anomalous. Such processes may have applications including anomaly detection in computer networks, distributed systems, other patterns of life applications including dynamic graphs (e.g., dynamic directed multi graphs), etc.

### CROSS-REFERENCE TO RELATED APPLICATION

This application claims the benefit of U.S. Provisional Patent Application No. 62/715,686 filed Aug. 7, 2018. The subject matter of this earlier filed application is hereby incorporated by reference in its entirety.

### STATEMENT OF FEDERAL RIGHTS

The United States government has rights in this invention pursuant to Contract No. 89233218CNA000001 between the United States Department of Energy and Triad National Security, LLC for the operation of Los Alamos National Laboratory.

### FIELD

The present invention generally relates to anomaly detection in a computer network, and more particularly, to an algorithmic method for more accurately modeling of whether new subgraphs that are observed locally in dynamic graphs, including dynamic directed multigraphs, are indicative of anomalous behavior.

### BACKGROUND

Statistical anomaly detection of dynamic graph motifs, which are sometimes described as induced subgraphs (e.g., edges, linear paths, stars, triangles, etc.), is challenging for the first observations of a motif since the zero to non-zero transition is numerically significant in counts. In other words, when a shape has not been seen before locally in a network graph, it is difficult to determine when the shape is seen for the first time whether it is actually anomalous (i.e., potentially indicative of malicious behavior). For certain types of traffic represented in dynamic directed multigraphs, new shapes of certain types occur relatively frequently for certain types of hosts and non-anomalous traffic, but the new occurrence of these shapes is scored individually as anomalous.

Existing edge-based modeling techniques tend to highly weight new observed shapes, which leads to may false positives. Also, manual whitelisting leads to false positives in all cases where these shapes are observed, without regard to the specific conditions under which they arise. Accordingly, an improved modeling approach may be beneficial.

### SUMMARY

Certain embodiments of the present invention may provide solutions to the problems and needs in the art that have not yet been fully identified, appreciated, or solved by conventional malicious actor detection technologies. For example, some embodiments pertain to an algorithmic method for more accurately modeling of whether new subgraphs that are observed locally in dynamic graphs, including dynamic directed multigraphs, are indicative of anomalous behavior.

In an embodiment, a computer program is embodied on a non-transitory computer-readable storage medium. The program is configured to cause at least one processor to create a community model of a portion or all of a computer network and a local dynamic directed multigraph of another portion of the computer network that is of interest. The community model includes a rate of creation of one or more new subgraphs with a given structure and one or more attributes associated with the structure. The computer program is also configured to cause the at least one processor to use the rate of creation of the one or more new subgraphs from the global model as a basis for determining a likelihood of observing each of the one or more new subgraphs in the local dynamic directed multigraph. When a subgraph is potentially anomalous based on the determined likelihood, the computer program is further configured to cause the at least one processor to determine whether the one or more attributes of each of the one or more new subgraphs have characteristics indicating that the one or more new subgraphs are likely not anomalous. Additionally, when the one or more attributes do not indicate that the one or more new subgraphs are likely not anomalous, the program is further configured to cause the at least one processor to provide a notification that at least one of the one or more new subgraphs is likely anomalous.

In another embodiment, a computer-implemented method includes using a rate of creation of a new subgraph with a given structure and one or more attributes associated with the structure from a community model of a portion or all of a network, by a computing system, as a basis for determining a likelihood of observing the new subgraph locally in the network. When the new subgraph is potentially anomalous based on the determined likelihood, the computer-implemented method also includes determining whether the one or more attributes of the new subgraph have characteristics indicating that the new subgraph is likely not anomalous. When the one or more attributes do not indicate that the new subgraph is likely not anomalous, the computer-implemented method further includes providing a notification that new subgraph is likely anomalous.

In yet another embodiment, a computer-implemented method includes using a rate of creation of a new subgraph with a given structure and one or more attributes associated with the structure from a community model, by a computing system, as a basis for determining a likelihood of observing the new subgraph locally in the network. When the new subgraph is potentially anomalous based on the determined likelihood, the computer-implemented method also includes determining whether the one or more attributes of the new subgraph have characteristics indicating that the new subgraph is likely not anomalous.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates an out star formed by a new printer.

FIG. 2 is a flowchart illustrating a process for determining whether new subgraphs that are observed locally in dynamic graphs are indicative of anomalous behavior, according to an embodiment of the present invention.

FIG. 3 is a block diagram illustrating a computing system configured to determine whether otherwise anomalous subgraphs are not anomalous due to one or more subgraph attributes, according to an embodiment of the present invention.

### DETAILED DESCRIPTION OF THE EMBODIMENTS

When a malicious actor gains entry to a network, path and/or star anomalies may be observed. A star anomaly may be indicative of a malicious actor using a compromised computing system to connect to other computing systems that it has access to, creating anomalies on multiple edges emanating from the compromised host. Anomalies often occur in extremely local areas of a network. However, such shapes are not always anomalous. When a new shape is first observed locally in a network, it is difficult to determine how unusual the occurrence of this shape is using conventional techniques. Indeed, previous approaches highly weighted certain shapes (e.g., stars and paths of at least a certain length) and indicated that they were anomalous. This lead to many false positives.

Accordingly, some embodiments of the present invention pertain to an algorithmic method for more accurately modeling of whether new subgraphs that are observed locally in dynamic graphs, including dynamic directed multigraphs, are indicative of anomalous behavior. Multigraphs can have multiple edges between a pair of nodes. A classic graph has exactly 0 or 1 edges between a pair of nodes. Dynamic multigraphs are useful for representing network behavior since each network connection/access/transaction/event can be represented as its own edge.

Community models of certain factors, such as the rate of creation of new subgraphs of given structures and labels, may provide a basis for measuring the likelihood of newly observed subgraphs. For instance, edge labels including attributes for these specific shapes, such as port numbers and/or other categories, may differentiate legitimate new local occurrences thereof from those that are anomalous. Some embodiments may have applications including, but not limited to, anomaly detection in computer networks, distributed systems, other patterns of life applications including dynamic graphs (e.g., dynamic directed multigraphs), and/or for any other suitable application without deviating from the scope of the invention.

Local models are for a specific node. As an example, the outdegree of each node in the network over time is often modeled in some embodiments. A desktop computer would typically have a low outdegree since it usually only communicates with a few servers. If that host then scans a local subnet, its outdegree might jump from a relatively low number to a relatively high number (e.g., from 5 to 250). This is a local anomaly. More specifically, the outdegree per destination port per node is modeled in some embodiments. In the same example, a local model for port 80 (web) may indicate that the host is usually talking to 2 web servers and a local model for port 445 (Windows®) may indicate that the host is usually talking to 3 Windows® servers. If a new out-star from that host is observed on port 161 (Simple Network Management Protocol (SNMP)), and has never had a non-zero outdegree, use of a community model may be beneficial.

A community model aggregates the behavior of some set of similar nodes. One case is a model of all nodes. Returning to the example above, the rate at which any host creates an out star on port 161 may be modeled. If there are 10,000 hosts and, on average, 5 hosts per day create such a new star (i.e., a 0.05% star creation rate), this community model can be used to estimate the likelihood of a particular host creating a new out star on port 161. As such, the community model may include ports and shape creation rates (e.g., a star, an edge, or any other desired shape) for any desired number of ports.

It should be noted, however, that communities can be more refined in some embodiments. For example, desktop computers could be one community, while printers could be another community, and servers a third community. This is useful if the different communities generate new out-stars on ports at different rates, for example. Communities could also be created for each business unit, any other suitable criteria that one believes correlates to common network behavior, and/or in any other desired grouping without deviating from the scope of the invention.

Some embodiments compute the likelihood for new local shapes, such as out stars, by using a community model of the frequency at which shapes with that edge label occur anywhere in the community model. The model of some embodiments learns that new shapes with a given label (e.g., a certain port number) more likely than instances of the same shape with other labels and allows the computed likelihood of new occurrences of these out stars to be known to be less anomalous than current techniques. More generally, this approach allows modeling of the creation of new (labeled or unlabeled) motifs including, but not limited to, out stars. This provides a better model of the actual likelihood of a new such instance as compared to techniques that use global models of individual edges or of motifs without edge label values.

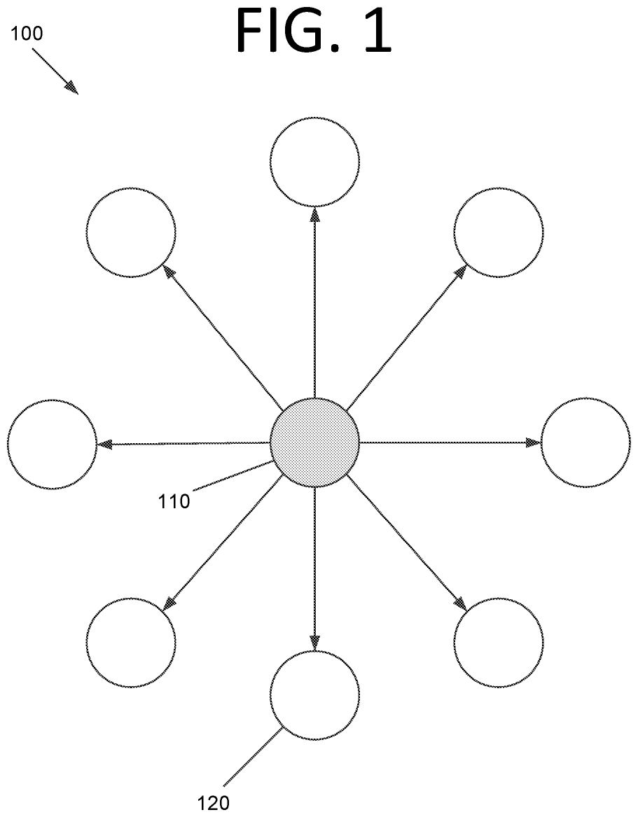

In certain embodiments, statistics for frequency with which edges occur from other applications could be used to determine the frequency and likelihood of a new occurrence locally. Structure creation can be modeled across the entire network graph. One example of a shape whose occurrence is locally new, but is not anomalous is an out star created by software of some printers when the printer is first turned on. For instance, HP® printer software will use port 161 for discovery of printers in the network to configure when the new software is first installed. An example of such an out star 100 is shown in FIG. 1. Node 110 seeks a series of connections with printers 120 on the local network.

However, this behavior is anomalous in most instances, and is frequently associated with a pattern demonstrated by malicious software of attackers who have infiltrated a device in a network. Accordingly, some embodiments consider attributes of new shapes that are otherwise anomalous to determine whether this is actually the case. The attribute-based approaches of some embodiments are novel and work much better than whitelisting, which blocks legitimate applications in addition to malicious ones.

Attributes used in some embodiments may include, but are not limited to, the port number, the edge duration (i.e., connection length), the connection frequency during a predetermined time period, the time of day, the type of device that is creating and/or receiving the edge, the size of the structure (e.g., a star with one or more specific outdegree may be normal for a certain application, but other outdegrees may be anomalous), based on a given location and/or area, and/or any other suitable attribute without deviating from the scope of the invention. In certain embodiments, multiple shapes may be required for a pattern to be considered anomalous. For instance, a triangle structure may not be anomalous, but a triangle coupled with a path of a certain length and then a star may be. These are all nonlimiting examples of categories that may be used for anomaly detection. In the case of the new printer software mentioned above, modeling new stars per port across the graph may account for this issue.

In order to form a network graph, paths through a network and connection shapes may be used, where a path or shape is a series of interconnected computing systems that connect to one another. In the graph, a “node” represents a computing system and an “edge” represents a sequence of connections over a predetermined time period between two computing systems (e.g., one connection, two connections, five connections, etc.). A stochastic model is generally developed for each edge in the network. Statistical tests may then be performed on the historic parameters of the model versus parameters estimated in a given window of time under consideration. Deviations from the historical parameters by a certain threshold may indicate an anomalous path or shape. An example of such a process can be found in U.S. Pat. No. 9,560,065, for instance.

Edge attribute information may be gleaned from Domain Name Server (DNS) requests (e.g., source Internet Protocol (IP) address and destination name) and/or other sources in some embodiments, which typically come to one or two points in most organizations. Such information may include, but is not limited to, the Media Access Control (MAC) address of the requesting device, the port number, the host name, the generation time stamp, the source and/or destination IP address, the operating system type, the record type (e.g., network connection state), etc. This information may be retrieved from one or more computing systems periodically (e.g., once per second) in order to keep the network graph up to date and move a sliding time window of a predetermined duration for the network. Naturally, the more frequent the polling, the more data that will be available for analysis, and the shorter the connection types that are likely to be captured.

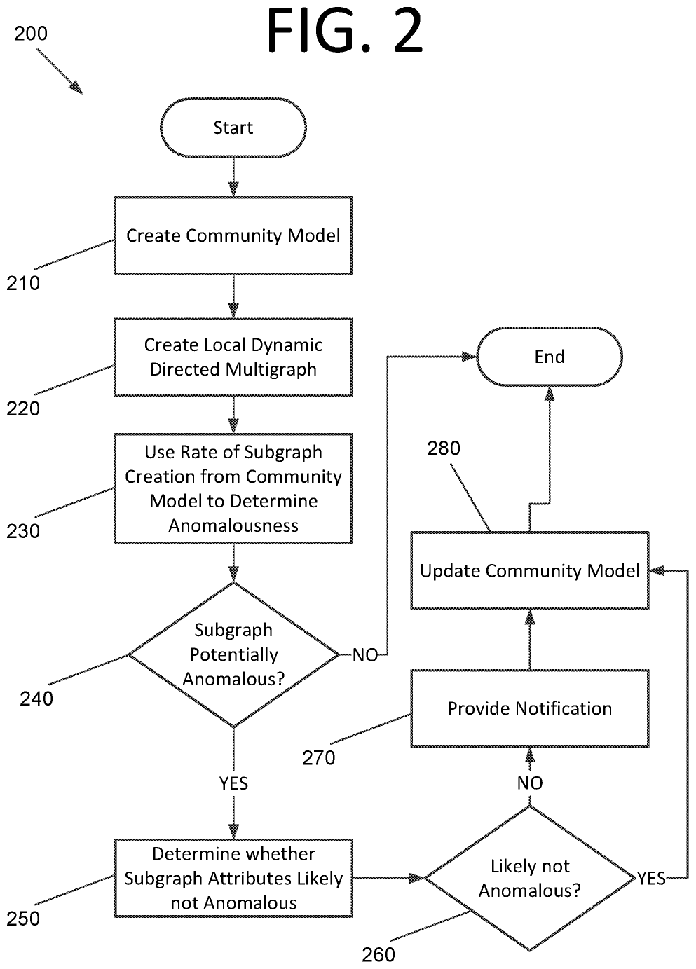

FIG. 2 is a flowchart 200 illustrating a process for determining whether new subgraphs that are observed locally in dynamic graphs are indicative of anomalous behavior, according to an embodiment of the present invention. The process begins with creating a community model of a larger portion of a computer network at 210. This larger portion may include the entire network, a set of nodes that typically behave similarly, or any other suitable grouping. The process also includes creating a local dynamic directed multigraph of a portion of the computer network that is of interest at 220. The community model includes a rate of creation of one or more new subgraphs with a given structure and one or more attributes associated with the structure. The one or more attributes may include, but are not limited to, a frequency with which the graph structure occurs, a port number, an edge duration, a connection frequency during a predetermined time period, a time of day, a type of device that is creating and/or receiving an edge, a size of the graph structure, a location and/or area within the community model where the new subgraph is occurring, or any combination thereof.

The rate of creation of the one or more new subgraphs from the community model is then used as a basis for determining a likelihood of observing each of the one or more new subgraphs in the local dynamic directed multigraph at 230. When a subgraph is potentially anomalous based on the determined likelihood at 240, it is determined whether the one or more attributes of each of the one or more new subgraphs have characteristics indicating that the one or more new subgraphs are likely not anomalous at 250. When the one or more attributes do not indicate that the one or more new subgraphs are likely not anomalous at 260, a notification is provided at 270 indicating that at least one of the one or more new subgraphs is likely anomalous. The community model is then updated at 280 such that the probability that the new subgraph structure with at least one attribute is anomalous is decreased over time, training the system. The models may update continuously to learn increased or decreased frequencies of events (i.e., a rate thereof).

In some embodiments, multiple shapes within a given new subgraph are required for a pattern in the new subgraph to likely be anomalous. For instance, a triangle structure may not be anomalous, but a triangle coupled with a path of a certain length and then a star may be. In certain embodiments, the one or more new subgraphs include linear paths, stars, triangles, or any combination thereof.

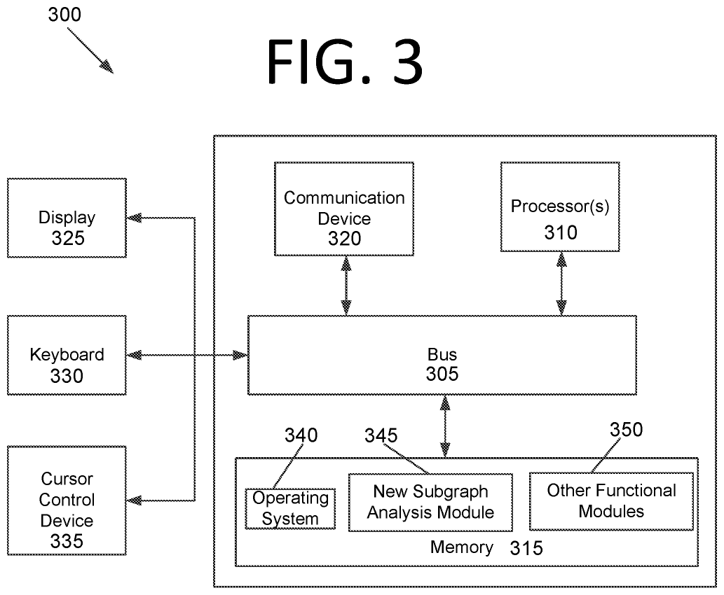

FIG. 3 is a block diagram illustrating a computing system 300 configured to determine whether otherwise anomalous subgraphs are not anomalous due to one or more subgraph attributes, according to an embodiment of the present invention. Computing system 300 includes a bus 305 or other communication mechanism for communicating information, and processor(s) 310 coupled to bus 305 for processing information. Processor(s) 310 may be any type of general or specific purpose processor, including a central processing unit (CPU), application specific integrated circuit (ASIC), field programmable gate array (FPGA), etc. Processor(s) 310 may also have multiple processing cores, and at least some of the cores may be configured to perform specific functions. Multi-parallel processing may be used in some embodiments. Computing system 300 further includes a memory 315 for storing information and instructions to be executed by processor(s) 310. Memory 315 can be comprised of any combination of random access memory (RAM), read only memory (ROM), flash memory, cache, static storage such as a magnetic or optical disk, or any other types of non-transitory computer-readable media or combinations thereof. Additionally, computing system 300 includes a communication device 320, such as a transceiver and antenna, to wirelessly provide access to a communications network.

Non-transitory computer-readable media may be any available media that can be accessed by processor(s) 310 and may include volatile media, non-volatile media, or both. The media may also be removable, non-removable, or both.

Processor(s) 310 are further coupled via bus 305 to a display 325, such as a Liquid Crystal Display (LCD), for displaying information to a user. A keyboard 330 and a cursor control device 335, such as a computer mouse, are further coupled to bus 305 to enable a user to interface with computing system. However, in certain embodiments such as those for mobile computing implementations, a physical keyboard and mouse may not be present, and the user may interact with the device solely through display 325 and/or a touchpad (not shown). Any type and combination of input devices may be used as a matter of design choice. In certain embodiments, no physical input device is present.

Memory 315 stores software modules that provide functionality when executed by processor(s) 310. The modules include an operating system 340 for computing system 300. The modules further include a new subgraph analysis module 345 that is configured to determine whether new subgraphs that are observed locally in dynamic graphs are indicative of anomalous behavior by employing any of the approaches discussed herein or derivatives thereof. Computing system 300 may include one or more additional functional modules 350 that include additional functionality.

One skilled in the art will appreciate that a “system” could be embodied as a server, an embedded computing system, a personal computer, a console, a personal digital assistant (PDA), a cell phone, a tablet computing device, or any other suitable computing device, or combination of devices. Presenting the above-described functions as being performed by a “system” is not intended to limit the scope of the present invention in any way, but is intended to provide one example of many embodiments of the present invention. Indeed, methods, systems and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, RAM, tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIG. 2 may be performed by a computer program, encoding instructions for the nonlinear adaptive processor to perform at least the process described in FIG. 2, in accordance with embodiments of the present invention. The computer program may be embodied on a non-transitory computer-readable medium. The computer-readable medium may be, but is not limited to, a hard disk drive, a flash device, a random access memory, a tape, or any other such medium used to store data. The computer program may include encoded instructions for controlling the nonlinear adaptive processor to implement the process described in FIG. 2, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer program embodied on a non-transitory computer-readable storage medium, the program configured to cause at least one processor to:
create a community model of a portion or all of a computer network and a local dynamic directed multigraph of another portion of the computer network that is of interest, the community model comprising a rate of creation of one or more new subgraphs with a given structure and one or more attributes associated with the structure;
use the rate of creation of the one or more new subgraphs from the community model as a basis for determining a likelihood of observing each of the one or more new subgraphs in the local dynamic directed multigraph; and
when a subgraph is potentially anomalous based on the determined likelihood:
determine whether the one or more attributes of each of the one or more new subgraphs have characteristics indicating that the one or more new subgraphs are likely not anomalous, and
when it is determined that the one or more attributes do not indicate that the one or more new subgraphs are likely not anomalous, the program is further configured to cause the at least one processor to provide a notification that at least one of the one or more new subgraphs is likely anomalous.

2. The computer program of claim 1, wherein the program is further configured to cause the at least one processor to decrease a probability that a new subgraph structure with at least one attribute is anomalous over time based on input from an analyst including the at least one attribute.

3. The computer program of claim 1, wherein the one or more attributes comprise a frequency with which the graph structure occurs, a port number, an edge duration, a connection frequency during a predetermined time period, a time of day, a type of device that is creating and/or receiving an edge, a size of the graph structure, a location and/or area within the community model where the new subgraph is occurring, or any combination thereof.

4. The computer program of claim 1, wherein multiple shapes within a given new subgraph are required for a pattern in the new subgraph to likely be anomalous.

5. The computer program of claim 1, wherein the one or more new subgraphs include linear paths, stars, triangles, or any combination thereof.

6. The computer program of claim 1, wherein the local dynamic directed multigraph comprises multiple nodes and multiple edges between at least one pair of nodes.

7. The computer program of claim 6, wherein each edge represents a connection, an access, a transaction, or an event.

8. The computer program of claim 6, wherein the community model aggregates behavior of a similar set of nodes.

9. The computer program of claim 6, wherein the community model comprises an outdegree of each node in the computer network.

10. The computer program of claim 1, wherein the community model comprises computing systems of a same type and/or computing systems in a same business unit.

11. A computer-implemented method, comprising:
using a rate of creation of a new subgraph with a given structure and one or more attributes associated with the structure from a community model of a portion or all of a network, by a computing system, as a basis for determining a likelihood of observing a new subgraph locally in the network; and
when the new subgraph is potentially anomalous based on the determined likelihood:
determining, by the computing system, whether the one or more attributes of the new subgraph have characteristics indicating that the new subgraph is likely not anomalous, and
when the one or more attributes do not indicate that the new subgraph is likely not anomalous, providing a notification that new subgraph is likely anomalous, by the computing system.

12. The computer-implemented method of claim 11, further comprising:
decreasing a probability that the structure of the subgraph with the one or more attributes is anomalous over time based on input from an analyst including the at least one attribute.

13. The computer-implemented method of claim 11, wherein the one or more attributes comprise a frequency with which the graph structure occurs, a port number, an edge duration, a connection frequency during a predetermined time period, a time of day, a type of device that is creating and/or receiving an edge, a size of the graph structure, a location and/or area within the community model where the new subgraph is occurring, or any combination thereof.

14. The computer-implemented method of claim 11, wherein
the subgraph comprises multiple nodes and multiple edges between at least one pair of nodes, and
each edge represents a connection, an access, a transaction, or an event.

15. The computer-implemented method of claim 14, wherein the community model aggregates behavior of a similar set of nodes.

16. The computer-implemented method of claim 14, wherein the community model comprises computing systems of a same type and/or computing systems in a same business unit.

17. A computer-implemented method, comprising:
using a rate of creation of a new subgraph with a given structure and one or more attributes associated with the structure from a community model, by a computing system, as a basis for determining a likelihood of observing the new subgraph locally in the network; and
when the new subgraph is potentially anomalous based on the determined likelihood, determining, by the computing system, whether the one or more attributes of the new subgraph have characteristics indicating that the new subgraph is likely not anomalous.

18. The computer-implemented method of claim 17, wherein when the one or more attributes do not indicate that the new subgraph is likely not anomalous, the method further includes:
providing a notification that new subgraph is likely anomalous, by the computing system.

19. The computer-implemented method of claim 17, further comprising:
decreasing a probability that the structure of the subgraph with the one or more attributes is anomalous over time based on input from an analyst including the at least one attribute.

20. The computer-implemented method of claim 17, wherein the one or more attributes comprise a frequency with which the graph structure occurs, a port number, an edge duration, a connection frequency during a predetermined time period, a time of day, a type of device that is creating and/or receiving an edge, a size of the graph structure, a location and/or area within the community model where the new subgraph is occurring, or any combination thereof.
